(19) United States
(12) Patent Application Publication
(10) Pub. No.: US 2009/0129776 A1
(43) Pub. Date: May 21, 2009

(54) WAVELENGTH-SELECTIVE SWITCH AND METHOD FOR CHANNEL-BY-CHANNEL SWITCHING FOR A WAVELENGTH-SELECTIVE SWITCH

(76) Inventor: Robert Schimpe, Ottobrunn (DE)

Correspondence Address: K&L Gates LLP, P.O. BOX 1135, CHICAGO, IL, 60690, US

(21) Appl. No.: 12/282,116

(22) PCT Filed: Mar. 8, 2007
(86) PCT No.: PCT/EP07/52159

§ 371 Date: Sep. 8, 2008

(30) Foreign Application Priority Data
Mar. 9, 2006 (DE) 102-006-011-001.3
Jul. 19, 2007 (DE) 10-2006-033.463.9

(51) Int. Cl. H04J 14/02

(52) U.S. Cl. 398/48

(57) ABSTRACT

A wavelength multiplex signal (WDM1, WDM2) having a plurality of channels is supplied to a wavelength-selective switch (WSS1, WSS2) which has a tunable, optical band rejection filter (TUF1, TUF2) at least one input or output. In addition, a controller is provided which is designed such that before a switching operation by the switch (WSS1, WSS2) a channel to be switched is locked by means of the band rejection filter (TUF1, TUF2), the switching operation is performed and then the channel is unlocked.

### CLAIM FOR PRIORITY

This application is a national stage application of PCT/EP2007/052159, filed Mar. 8, 2007, which claims the benefit of priority to German Application No. 10 2006 011 001.3, filed Mar. 9, 2006, which claims priority to German Application No. 10 2006 033 463.9, filed Jul. 19, 2006, the contents of which hereby incorporated by reference.

### TECHNICAL FIELD OF THE INVENTION

The invention relates to a wavelength-selective switch and method for channel-by-channel switching for a wavelength-selective switch.

### BACKGROUND OF THE INVENTION

One-dimensional wavelength-selective switches, that is to say those having one-dimensional rows of switches, are not non-blocking or non-hitless during the switching operation. They are constructed in such a manner that an input-side wavelength division multiplex signal which is supplied to an input of the wavelength-selective switch (WSS for short) is subdivided into the individual wavelength division multiplex channels or wavelength division multiplex frequency bands and each channel or each band is supplied to a deflecting mirror. In this case, channels of the inputs, which are respectively at the same wavelength or frequency, are supplied to a deflecting mirror. That is to say there is one mirror for each channel or band. This deflecting mirror can be changed only in one plane in the case of one-dimensional WSSs. The position of the deflecting mirrors diverts the respective channel of an input to an output, with the result that an output-side wavelength division multiplex signal is formed and output at the output.

In an analogous manner, a wavelength-selective switch may have only one input and a plurality of outputs. In this case, an input-side wavelength division multiplex signal is subdivided into the individual wavelength division multiplex channels and each channel or each band is supplied to a deflecting mirror. The deflecting mirror diverts a channel to a particular output, with the result that an output-side wavelength division multiplex signal is respectively formed and output here. In the case of the one-dimensional WSS, a switching operation is carried out by changing the deflecting mirror in one plane, with the result that the optical signal of a channel is deflected from another input to the output or from the input to another output. In this case, the deflecting mirror is pivoted during the switching operation. This respectively connects all inputs or outputs which are between the “old” and the “new” input or output. If, for example, the first channel is switched through from the third input to the output and the first channel of the seventh input is now intended to be switched to the output, the fourth input, the fifth input and the sixth input are briefly connected to the output during the switching operation. If optical signals are now applied to these inputs in the first channel in the example, this may result in brief “power peaks” in the optical system, which power peaks can cause interference and, in the extreme case, may result in the breakdown of the flow of data in this and other channels.

If, for example, the fourth channel is analogously switched through from the input to the second output and is now intended to be switched to the eighth output, the input signal of the fourth channel is briefly switched to the third output, the fourth output, the fifth output, the sixth output and the seventh output during the switching operation until the eighth output is reached. If a signal is still applied to the input during the switching operation, an optical signal is briefly output at each of the outputs in between or a “power peak” is produced, which can lead to problems which have already been mentioned.

Even in the case of wavelength-selective multidimensional “hitless” switches, the suppression of crosstalk by switches is not always complete, with the result that interference caused by other channels also occurs in this case during operation.

### SUMMARY OF THE INVENTION

In one-dimensional switches, the channel to be switched is selected according to the invention by a tunable optical bandstop filter before a switching operation, with the result that, in the case of a WSS having one input, the channel to be switched is blocked or is not available on the input side or, in the case of a WSS having one output, the channel to be switched is blocked on the output side or said channel is not output on the output side, the switching operation is then carried out, and the filter is then deselected, with the result that all channels are allowed through. For this purpose, an optical bandstop filter which can be tuned with channel granularity or more finely is arranged at the input or output and is controlled in a corresponding manner. This has the advantage that power peaks which arise as a result of the switching operation cannot arise on the output side or cannot be “tapped off” on the input side.

A multiwavelength blocker is may be used instead of a bandpass filter. Upstream of the wavelength-selective switch, the channels to be attenuated (that is the signals, or a corresponding attenuator is set in the channel) are selectively attenuated to different extents by a multiwavelength blocker, with the result that the signals already have the required spectral distribution of optical power on the input side; or downstream of the wavelength-selective switch, a WSS having one output is used to selectively attenuate the signals in such a manner that they receive the required spectral distribution of optical powers on the output side. For this purpose, an optical band filter which can be spectrally programmed at least with channel granularity or attenuation is arranged at the input or output and is controlled in a corresponding manner. This has the advantage that the crosstalk suppression which is inherent in the WSS is not reduced by channel-by-channel optical attenuation in the WSS.

The invention may be used when using one-dimensional switches, but improvements in crosstalk can also be achieved in the case of multidimensional switches. In particular, the use of multiple wavelengths enables both simple channel selection and the use as an equalizer in order to set the levels of all channels to the same level values or desired level values.

### BRIEF DESCRIPTION OF THE DRAWINGS

One exemplary embodiment of the invention is explained in more detail below using the drawing, in which:

FIG. 1 shows a drawing for explaining a wavelength-selective switch having a plurality of inputs and one output.

FIG. 2 shows a drawing for explaining a wavelength-selective switch having one input and a plurality of outputs.

FIG. 3 shows two arrangements according to the invention for a one-dimensional wavelength-selective switch.

FIG. 4 shows an optical network node having wavelength-selective switches according to the invention.

FIG. 5 shows a variant having a further wavelength-selective switch.

### DETAILED DESCRIPTION OF THE INVENTION

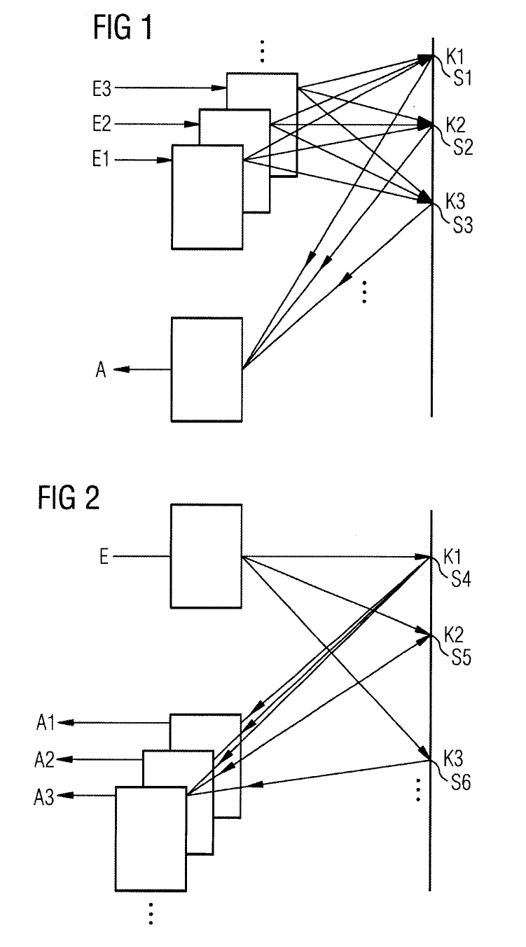

FIG. 1 shows a drawing for explaining a wavelength-selective switch. The latter has a plurality of inputs E1, E2, E3, . . . which are each supplied with a wavelength division multiplex signal. The latter is respectively subdivided into its channels or wavelength bands K1, K2, K3, . . . , the same channels of the inputs respectively being supplied to a mirror. In the example, the first channels K1 of the inputs E1, E2, E3, . . . are supplied to the first mirror or deflecting mirror S1. All second channels K2 of the inputs E1, E2, E3, . . . are supplied to the second mirror or deflecting mirror S2. All third channels K3 of the inputs E1, E2, E3, . . . are supplied to the third mirror or deflecting mirror S3, etc.

During a switching operation of the first channel K1, for example, from the input E1 to the input E3, the mirror S1 is tilted in such a manner that the optical signal of the third input is now transmitted to the output A. In the case of a one-dimensional WSS, the second input E2 is inevitably briefly connected to the output A in this case during the switching operation, with the result that a power peak may arise if an optical signal is applied to the second input E2 in the first channel K1.

FIG. 2 shows a drawing for explaining a further wavelength-selective switch according to FIG. 1, with the difference that one input and a plurality of outputs are provided. A wavelength division multiplex signal which is supplied to the input E is subdivided into its channels or wavelength bands K1, K2, K3, . . . , each of which is supplied to a mirror. In the example, the first channel K1 is supplied to the fourth mirror or deflecting mirror S4, the second channel K2 is supplied to the fifth mirror or deflecting mirror S5, the third channel K3 is supplied to the sixth mirror or deflecting mirror S6, etc. These mirrors respectively divert the optical signal of the respective channel to one of the outputs A1, A2, A3, . . . . In the case of a switching operation of the first channel K1, for example, from the output A3 to the output A1, the mirror S4 is tilted in such a manner that the optical signal is now transmitted to the output A1. In the case of a one-dimensional WSS, the second output A2 is inevitably briefly connected to the input E in this case during the switching operation, with the result that a power peak may arise at the output A2 if an optical signal is applied to the input E.

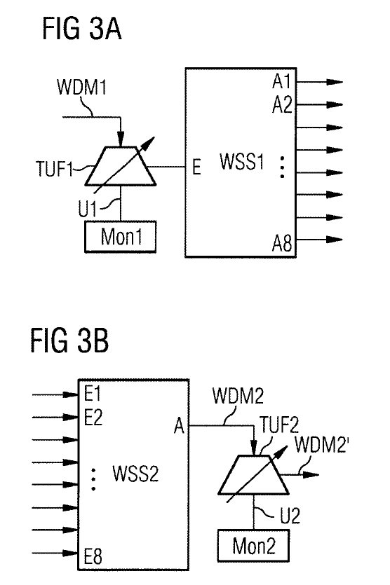

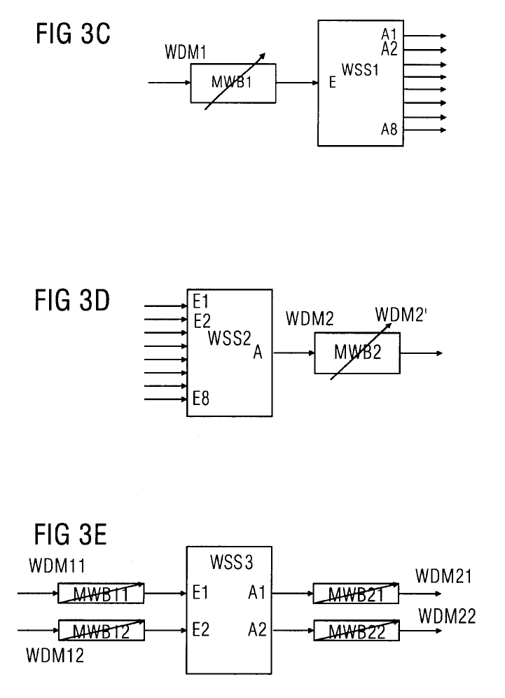

FIG. 3a shows a first wavelength-selective switch WSS1 having one input E and eight outputs A1, . . . , A8, a first tunable optical bandstop filter TUF1 being connected according to the invention upstream of said switch. This bandstop filter has a so-called overflow connection U1 at which the blocked band is output. A monitor device Mon1 is connected here in the example according to FIG. 3a.

A wavelength division multiplex signal WDM1 is supplied to the tunable optical bandstop filter TUF1 and passes, via the latter, to the first wavelength-selective switch WSS1. Here, the entire signal can be output at one output or a correspondingly switched part can be respectively output at different outputs.

For example, a first channel of the input-side wavelength division multiplex signal WDM1 is output at the output A2, a second channel is output at the output A6, etc.

If the first channel is now intended to be output at the output A7, the one-dimensional wavelength-selective switch WSS1 switches through this channel from the output A2 to the output A7. In this case, the first channel is briefly output at the output 3, then at the output 4, at the output 5, at the output 6 until the final switching state of the output 7 has been reached. In this case, signal peaks briefly occur at the outputs in between, which signal peaks originate from the first channel of the wavelength division multiplex signal WDM1. Said peaks may result in undesirable effects in the components connected downstream of these outputs.

Before a switching operation, for example of the first channel, the tunable optical bandstop filter TUF1 is now tuned according to the invention to the first channel, with the result that said channel no longer passes to the input of the wavelength-selective switch WSS1. All other channels remain unaffected by this since only the channel(s) to be switched is/are blocked. The switching operation is then carried out in the wavelength-selective switch 1, for example from output A2 to output A7. The tunable optical bandstop filter TUF1 is then deselected, with the result that the entire wavelength division multiplex signal WDM1 passes again to the input E of the first wavelength-selective switch WSS1 and the first channel can therefore also be output at the output A7.

FIG. 3b shows a second wavelength-selective switch WSS2 which is inversely constructed and operated in an analogous manner. This switch has a plurality of inputs E1 to E8 and one output A. Its method of operation is analogous to the description relating to FIG. 1. According to the invention, a second tunable optical bandstop filter TUF2 is connected to the output A. This filter likewise has a so-called overflow U2 at which the blocked band(s) or channel(s) is/are output. In the example, only one monitor device Mon2 is connected here.

The inputs E1, . . . , E8 are respectively supplied with wavelength division multiplex signals or individual channels of the latter. These are at least partially combined using the wavelength-selective switch WSS2 to form a wavelength division multiplex signal WDM2 which is output at the output A. The wavelength-selective switch WSS2 may also have a plurality of outputs which each output a wavelength division multiplex signal.

According to the invention, a channel to be switched is blocked by the second tunable optical bandstop filter TUF2 before the switching operation, the channel is switched to its new input and is then allowed through.

If, for example, the third channel is switched from the input E2 to the output and the third channel is intended to be switched from the input E6 to the output A, with the result that the third channel is no longer output at the output A from the input E2 but rather from the input E6, the third channel of the input E3, then of the input E4, then of the input E5 is tapped off during the changeover operation according to the prior art until the final switching state is produced at the input E6. If optical signals with different levels, which are not actually intended to be switched through to the output A, are now applied to the inputs E3 to E5 in the third channels, power peaks or signal peaks which may result in interference are briefly output at the output A.

Before a changeover operation of the third channel, the latter is now blocked according to the invention by the second tunable optical bandstop filter TUF2, the third channel is changed over from the input E2 to input E6, and the tunable optical bandstop filter TUF2 is deselected again after the changeover operation, with the result that all channels of the wavelength division multiplex signal WDM2 are output at the tunable optical bandstop filter TUF2 as the wavelength division multiplex signal WDM2′. It goes without saying that a plurality of channels may also be changed over at the same time and a correspondingly arranged tunable optical bandstop filter must block the channels to be switched.

Furthermore, a wavelength-selective switch WSS may also have a plurality of inputs and outputs, that is to say may be an m x n WSS having tunable optical bandstop filters which are connected to its inputs and outputs according to the invention.

FIG. 3c shows a first wavelength-selective switch WSS1 having one input E and eight outputs A1, . . . , A8, a multiwavelength blocker MWB1, that is to say an optical bandstop filter which can be programmed for each channel, being connected according to the invention upstream of said switch.

A wavelength division multiplex signal WDM1 is supplied to the multiwavelength blocker band filter MWB1 and passes, via the latter, to the first wavelength-selective switch WSS1. Here, the entire signal can be output at one output or a correspondingly switched part can be respectively output at different outputs.

For example, a first channel of the input-side wavelength division multiplex signal WDM1 is output at the output A2, a second channel is output at the output A6, etc. If the first channel is now intended to be provided with a different optical power, the attenuation for this channel is changed according to the invention in the multiwavelength blocker MWB1.

The settings in the WSS1 remain unaffected by this. In this WSS1, the demands imposed on crosstalk suppression may be made more stringent since a plurality of signals may run through the WSS1 in the same spectral range and may be jointly superimposed at the output port in an interfering manner. Channels which are not used may be masked and the desired levels may be set in the remaining channels.

FIG. 3d shows a second wavelength-selective switch WSS2 which is “inversely” constructed and operated in an analogous manner. This switch has a plurality of inputs E1 to E8 and one output A. Its method of operation is analogous to the description relating to FIG. 1. According to the invention, a multiwavelength blocker MWB2 is connected to the output A.

The inputs E1, . . . , E8 are respectively supplied with wavelength division multiplex signals or individual channels of the latter. These are at least partially combined using the wavelength-selective switch WSS2 to form a wavelength division multiplex signal WDM2 which is output at the output A. The wavelength-selective switch WSS2 may also have a plurality of outputs which each output a wavelength division multiplex signal. The channels whose output powers are to be changed are changed by the second multiwavelength blocker MWB2 by means of different attenuation.

The individual channels are at least partially combined using the wavelength-selective switch WSS2 to form a wavelength division multiplex signal WDM2 which is output at the output A. The wavelength-selective switch WSS2 may also have a plurality of outputs which each output a wavelength division multiplex signal.

A channel whose output power is to be changed is changed, in terms of its attenuation, by the multiwavelength blocker MWB2 and the settings in the WSS2 remain unaffected by this. Of course, this also again applies to a plurality of channels whose output power can be simultaneously changed.

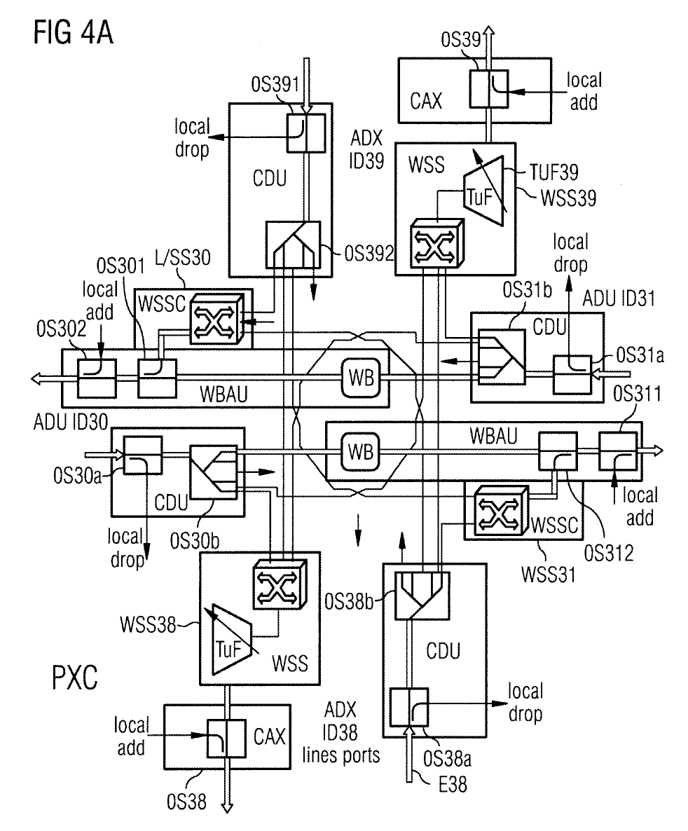

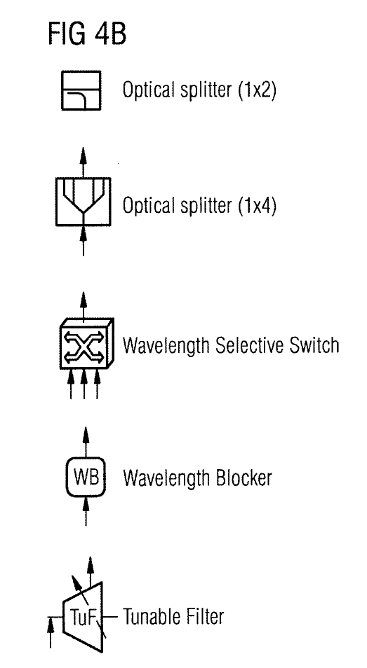

FIG. 4 shows an optical network node PXC having wavelength-selective switches according to the invention. In this case, a tunable optical bandstop filter TUF is respectively connected downstream of some of the wavelength-selective switches WSS. The optical network node PXC has a plurality of inputs and outputs or line ports ID30, ID31, ID38, ID39. A wavelength division multiplex signal E38 is supplied to the line port ID38. Here, it passes to a first optical splitter OS38a, which branches off a local signal, and then to a second optical splitter OS38b which respectively outputs the WDM signal E38 in the output directions. In the example, the signal passes to the line ports ID30, ID31, TD39. The WDM signal which passes to the line port ID39 is supplied in this case to a third wavelength-selective switch WSS39 according to the invention which has a tunable optical bandstop filter TUF39 on the output side. The switch WSS39 is adjoined by a further splitter OS39 which is operated as a combiner. WDM signals of other line ports, for example the line port ID31, ID30, are supplied to the wavelength-selective switch WSS39.

This construction is implemented in an analogous manner for the other directions. In addition, a wavelength blocker WB can be connected between a second optical splitter and a wavelength-selective switch or a combiner (this may be a splitter which is operated as a combiner) in order to block certain wavelengths, for example for “local add” and “local drop”, as shown in FIG. 4.

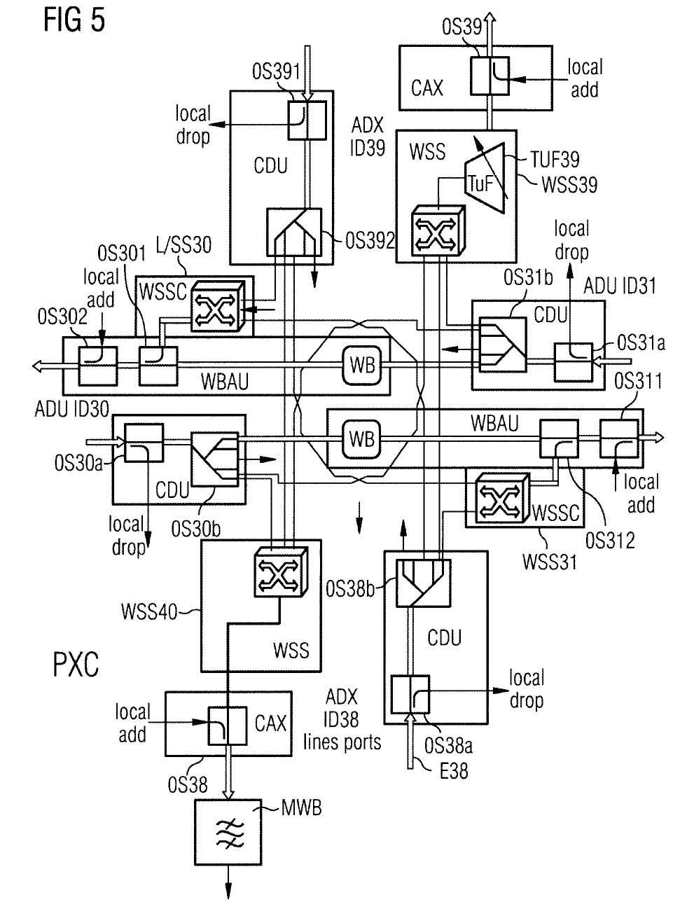

FIG. 5 shows a variant having a further multiwavelength blocker MWB. The latter is connected downstream of a wavelength-selective switch WSS40, which replaces the WSS38 from FIG. 4A, and the combiner OS38. The multiwavelength blocker MWB operates as a channel-by-channel equalizer during operation and/or as a signal blocker when changing over/rearranging channels. The multiwavelength blocker MWB is arranged at the output after all channels have been combined. The MWB can also be advantageously used at the input of the WSS1 in FIG. 3a.

1. A wavelength-selective switch for wavelength division multiplex signals, comprising:
a plurality of channels,
wherein
the wavelength-selective switch has a tunable optical bandstop filter at least one input or output; and
a controller configured such that, before a switching operation of the switch, a channel to be switched is blocked using the bandstop filter, the switching operation is carried out and the channel is then unblocked.

2. The wavelength-selective switch as claimed in claim 1, wherein
the wavelength-selective switch has at least one input and a plurality of outputs, the tunable optical bandstop filter is connected upstream of the inputs, and, in the event of an input-side channel being changed over from a first to a second output, the controller blocks the channel to be switched.

3. The wavelength-selective switch as claimed in claim 1, wherein
the wavelength-selective switch has at least one outputs and a plurality of inputs, the tunable optical bandstop filter is connected downstream of the output, and, in the event of a channel which is available at the output being changed over from a first to a second input, the controller blocks the channel to be switched.

4. The wavelengths-selective switch as claimed in claim 1, wherein
the tunable optical bandstop filter has an optical overflow connection at which the respectively blocked channel is available.

5. The wavelength-selective switch as claimed in claim 4, further comprising
a monitor device is connected to the overflow connection.

6. The wavelength-selective switch as claimed in claim 1,
wherein
a multiwavelength blocker is arranged instead of the optical bandstop filter, which multiwavelength blocker is used as an equalizer.

7. The wavelength-selective switch as claimed in
claim 1, wherein
it is in the form of a one-dimensional wavelength-selective switch.

8. An optical network node
at least one wavelength-selective switch a plurality of channels, wherein
the wavelength-selective switch has a tunable optical bandstop filter at least one input or output; and
a controller configured such that, before a switching operation of the switch, a channel to be switched is blocked using the bandstop filter, the switching operation is carried out and the channel is then unblocked.

9. A method for channel-by-channel switching for a wavelength-selective switch which is supplied with a wavelength division multiplex signal having a plurality of channels, comprising:
connecting a tunable optical bandstop filter upstream or downstream of the wavelength-selective switch,
such that, before a switching operation of the wavelength-selective switch, the tunable optical bandstop filter blocks the channel frequency to be switched; and
performing the switching operation of the wavelength-selective switch,
such that, after the switching operation, the tunable optical bandstop filter unblocks the switched channel frequency.

10. The method as claimed in claim 9, wherein
the wavelength-selective switch has an inputs and a plurality of outputs, and the tunable optical bandstop filter is connected upstream of the inputs, and
in the event of an input-side channel being changed over from a first to a second output, the channel to be switched is blocked.

11. The method as claimed in claim 9, wherein
the wavelength-selective switch has an output and a plurality of inputs, and the tunable optical bandstop filter is connected downstream of the output, and in the event of a channel which is available at the output being changed over from a first to a second input, the channel to be switched is blocked.

12. The method as claimed in claim 9, wherein a multiwavelength blocker is used instead of the tunable optical bandstop filter, which multiwavelength blocker is used as an equalizer.

13. The method as claimed in claim 9, wherein
a one-dimensional wavelength-selective switch is.
